(19) United States
(12) Patent Application Publication
(10) Pub. No.: US 2006/0219265 A1
(43) Pub. Date: Oct. 5, 2006

(54) Actuator for an aerosol can device

(76) Inventors: Doris S. Shieh, Oakland, CA (US); Timothy J. Kennedy, Oakland, CA (US); Ricardo Ruiz de Gopegui, Oakland, CA (US); David T. Faubion, Rockport, IN (US); William T. Nally, Evansville, IN (US)

Correspondence Address: THE CLOROX COMPANY;Legal Services, P.O. Box 24305, Oakland, CA, 94623-1305, US

(21) Appl. No.: 11/099,171

(22) Filed: Apr. 4, 2005

(51) Int. Cl. B08B 3/04

(52) U.S. Cl. 134/22.1; 134/22.11; 134/22.12; 134/34; 222/402.11

(57) ABSTRACT

Provided is an actuator for use with an aerosol can drain clearing device that removes a drain blockage with pressurized gas contained in the aerosol can. The actuator includes an actuator piece with an actuator dome having a dome aperture therethrough and at least one sidewall that circumscribes the dome aperture. One end of the sidewall is slanted and forms a gas-tight seal with a sink drain flange circumscribing a sink drain. In one embodiment, the actuator includes a coupling piece configured to slidably coupled to the actuator piece at one portion of the coupling piece. In use with a pressurized gas aerosol can, the aerosol can is coupled to another portion of the coupling piece.

### BACKGROUND OF THE INVENTION

1. Field of the Invention

The present invention relates to devices for clearing blocked fluid drains, conduits and the like. More particularly, the present invention relates to a pressure sealing actuator for use with devices that dispense pressurized gas into a sink drain to produce a clearing of a drain blockage.

2. Description of the Related Art

The problem of clearing drains, such as household bathroom and kitchen sink drains, of blockages is a constantly reoccurring one. Many methods and devices have been used in the past in attempts to solve this problem.

Chemical drain openers are well known in the art, as is their principle of chemically attacking blockage material to effect its breakup or dislodgment. However, some blockages are not susceptible to such chemical removal, at least not very easily. Furthermore, the chemical removal methods typically take time to work and accordingly do not satisfy a user's desire for quick removal of a drain blockage causing frustrating or unsanitary conditions. In addition, chemicals typically used in this application are caustic or corrosive and present safety hazards to users.

Mechanical techniques for removing blockages are well known and usually quick acting. The common plumber's helper, which is a simple plunger, operates by creating a pressure surge in the drain to effectively remove the blockage from its point of lodgment. More recently, devices have been developed which use stored compressed gas for creating the pressure surge necessary for mechanical blockage removal.

With the advent of aerosol containers, a safe reliable source of pressurized gas was made available for use with drain blockage removal devices using pressurized gas. As is well known to those of ordinary skill in the art, aerosol containers typically comprise a cylindrical sidewall coupled to a domed top piece at a crimped, rounded-over top seam, sometimes referred to as a chime. An aerosol can valve, which when activated releases pressurized gas in the aerosol container through an aperture in a valve stem and an aperture in the domed top price, projects from the dome tope piece. An example of an aerosol container drain clearing devices is U.S. Pat. No. 3,823,427 by Pittet, which utilizes an aerosol container having a conventional inverted vertical action aerosol valve of reciprocating type by which a liquefied gas or propellant within the container may be selectively discharged. Breznok, et al., U.S. Pat. No. 4,034,427, Hsiao, U.S. Pat. No. 6,526,601 B1, and Allenbaugh et al., U.S. Pat. No. 6,550,074 B1, also disclose devices that utilized pressurized gas in an aerosol container to mechanically remove drain blockages.

An important feature necessary for effective removal of blockages from drains that utilize gas pressure is a sealing member that effects a substantially gas-tight seal between the gas dispensing container and the drain opening. Without an effective seal, gas is lost to the surrounding atmosphere and blockage removal pressure is reduced. Some devices of the prior art typically utilized a rigid or elastomeric cup, the end or rim of which was place in abutting contact with the sink or other surface, such as a flange that typically surrounded the drain opening, to effect a gas-tight seal. Pressurized gas was then introduced into the cup, thereby pressurizing the drain and impinging on the blockage. Other prior art devices utilized a flexible or elastomeric cone that fit within the drain opening, thereby effecting a seal where the diameter of the sealing cone equaled the inside diameter of the drain opening. Pressurized gas was then introduced into the drain through a passageway in the cone thereby pressurizing the drain and impinging on the blockage.

However, these prior art sealing members, particularly cone type sealing members, were not usable in drains that included remotely actuated drain stoppers, sometimes referred to as drain plugs, typically found in bathroom sinks. Further, where a faucet was positioned directly above the drain, prior art pressurized gas drain cleaners utilizing aerosol cans were not usable since the aerosol cans typically contacted the faucet, thereby precluding a gas-tight seal of the sealing member at the drain opening. Often, prior art sealing members were only suitable for one type of drain, such as a bathroom sink drain or a kitchen sink drain. What is needed is an aerosol can actuator for use with a pressurized gas sink drain clearing device that provides an effective gas-tight seal at a variety of drain openings and that is still operable when a faucet is positioned directly above the drain.

### SUMMARY OF THE INVENTION

In one embodiment according to the principles of the present invention, provided is an actuator for use with a pressurized gas sink drain clearing device comprising an actuator piece comprising an actuator dome having an actuator aperture therethrough. The actuator further comprises at least one sidewall coupled to the actuator dome. The sidewall has a sidewall first end and a sidewall second end opposite the sidewall first end. All the points comprising the sidewall second end lie in a planar surface that is inclined with respect to the sidewall. The sidewall is further configured as a closed surface that circumscribes the actuator dome aperture through the actuator dome.

In use of the actuator with a pressurized gas sink drain clearing device, the sidewall second end of the actuator is placed in abutting contact with the sink surface or drain flange at the sink drain opening to circumscribe the drain opening. The abutting contact effects a substantially gas-tight seal at the interface between the actuator sidewall second end and the sink surface or drain flange. Pressurized gas is next introduced through the actuator aperture. The sidewall and actuator dome of the actuator and the substantially gas-tight seal contain the pressurized gas. The pressure of the gas impinges on any blockage in the sink drain through the sink drain opening. In this manner, the blockage is motivated to travel along the drain to an exit point of the drain, such as a sewer main, or to breakup during such travel eliminating its drain blocking effect.

In another embodiment according to the principles of the present invention, the actuator further comprises a coupling piece coupled to and slidably engaging the actuator piece at one portion of the coupling piece. In use with a pressurized gas drain cleaning device, a pressurized gas aerosol can is coupled to another portion of the coupling piece. In one aspect of the present invention, the actuator piece and the coupling piece of the actuator provide a safety feature that tends to preclude operation of the pressurized gas drain cleaning device by a child.

### BRIEF DESCRIPTION OF THE DRAWINGS

The foregoing aspects and others will be readily appreciated by the skilled artisan from the following description of illustrative embodiments when read in conjunction with the accompanying drawings, wherein:

FIG. 1A is a bottom perspective view of an embodiment of an actuator piece in accordance with the principles of the present invention;

FIG. 1B is a side view of the actuator piece shown in FIG. 1A;

FIG. 1C is a bottom plan view of the actuator piece shown in FIG. 1A;

FIG. 1D is a top plan view of the actuator piece shown in FIG. 1A;

FIG. 2 is a cross-sectional side view of the actuator piece shown in FIG. 1A taken along the line 2′ [symbol] 2′ and positioned for use with a pressurized gas drain clearing device;

FIG. 3 is a close-up view of the area shown in dotted line and referenced by reference number 3′ on FIG. 2;

FIG. 4A is a cross-sectional side view of the actuator piece shown in FIG. 1A positioned in abutting contact with a bathroom sink drain flange of a typical bathroom sink;

FIG. 4B is a cross-sectional side view of the actuator piece shown in FIG. 1A positioned in abutting contact with a kitchen sink drain flange of a typical kitchen sink;

FIG. 5 is an assembly view of one embodiment of an actuator that includes a coupling piece slidably coupled to an actuator piece;

FIG. 6 is an exploded isometric view of the actuator piece and the coupling piece shown in FIG. 5;

FIG. 7 is a cross-sectional side view of the actuator shown in FIG. 5 after the valve actuator element receiver of the coupling piece is snap-fitted over valve actuator element of the actuator piece; and

FIG. 8 is a bottom plan view of the coupling piece shown in FIG. 5.

### DETAILED DESCRIPTION

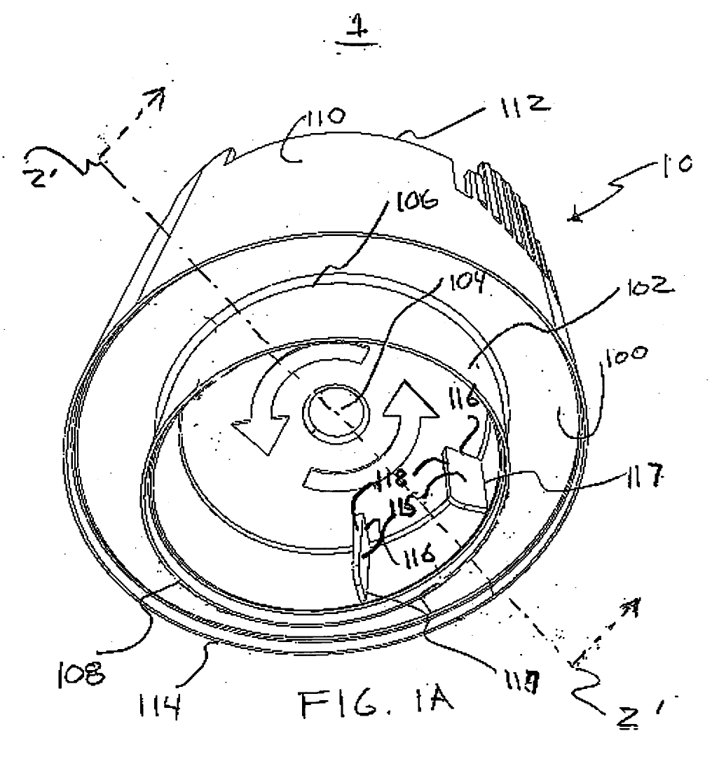

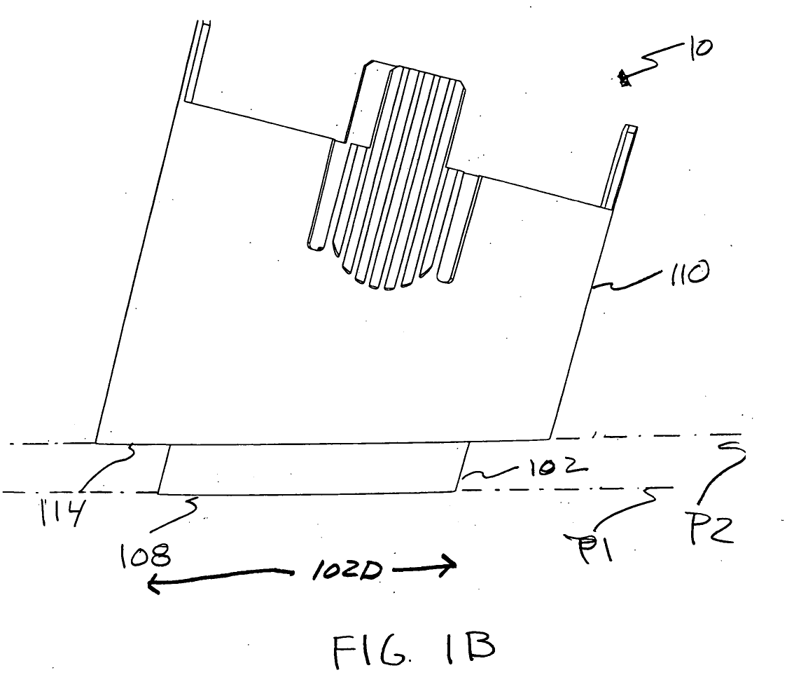

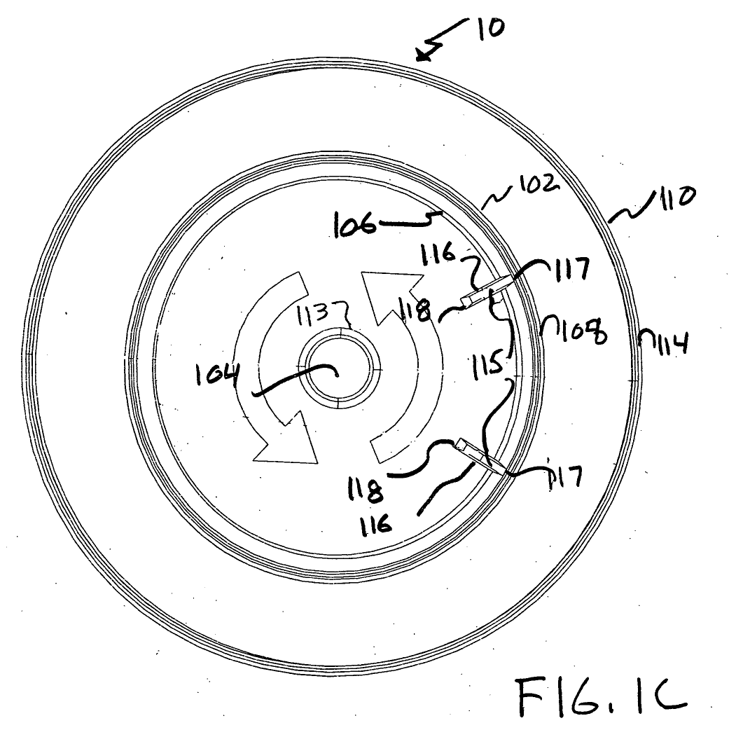

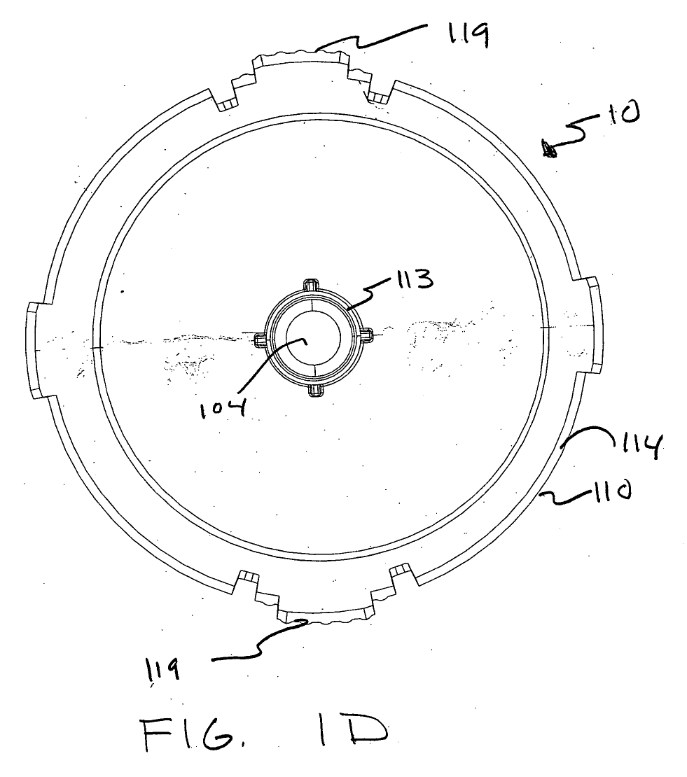

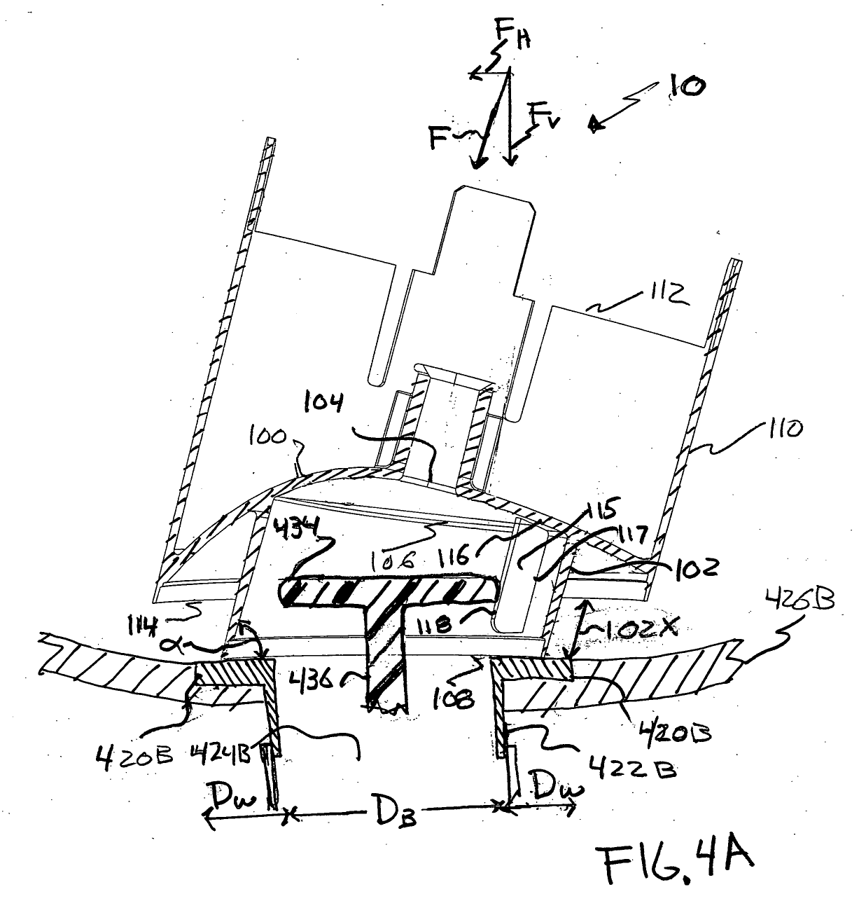

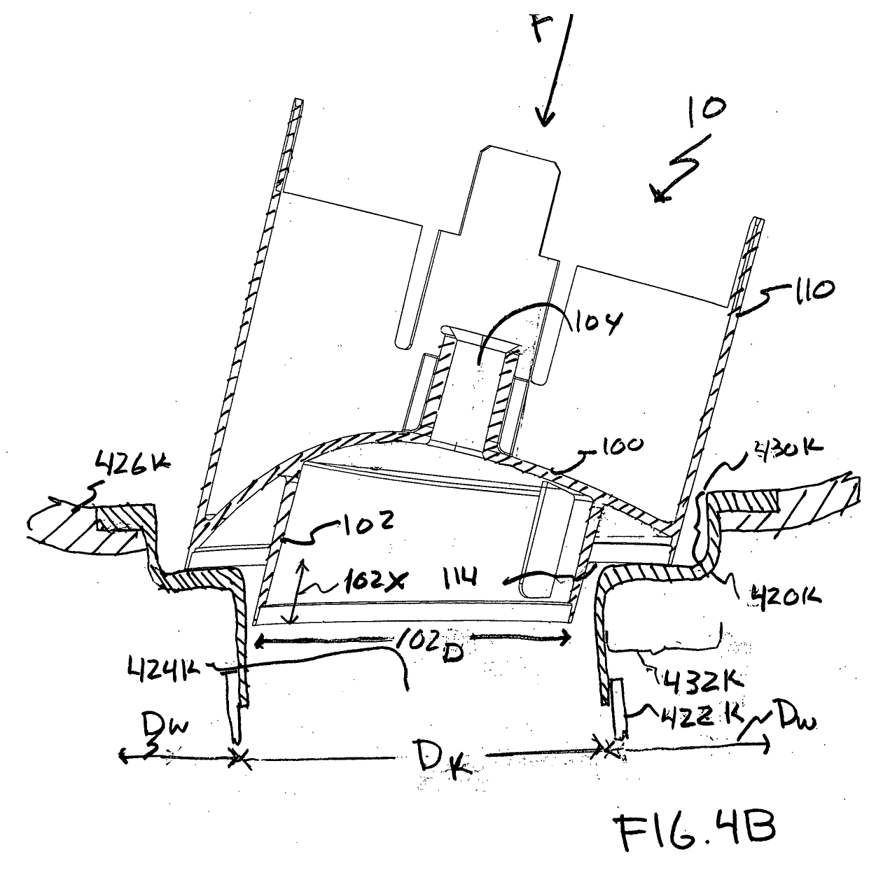

Reference will now be made to the drawings wherein like numerals refer to like parts throughout. FIG. 1A is a bottom perspective view of an embodiment of an actuator 1 in accordance with the principles of the present invention. As used herein, positional terms, such as “bottom” and “top” and the like, and directional terms, such as “up” and “down” and the like, are employed for ease of description in conjunction with the drawings. These terms are not meant to indicate that the components of the present invention must have a specific orientation except when specifically set forth below. When viewed from the bottom, actuator 1 comprises an actuator piece 10 having a concavely shaped actuator dome 100 and a cylindrically shaped inner sidewall 102 coupled to actuator dome 100. Inner sidewall 102 has an inner sidewall first end 106 and an inner sidewall second end 108 opposite inner sidewall first end 106. In the embodiment shown in FIG. 1A, inner sidewall 102 is coupled to actuator dome 100 at inner sidewall first end 106. Further, actuator dome 100 defines an actuator aperture 104 through actuator dome 100 and inner sidewall 102 circumscribes actuator aperture 104 at actuator dome 100. As described more fully below with reference to FIG. 4B, in one embodiment, actuator piece 10 further includes a cylindrically shaped outer sidewall 110 having an outer sidewall first end 112 and an outer sidewall second end 114 opposite outer sidewall first end 112.

FIG. 1B is a side view of actuator piece 10 shown in FIG. 1A. All points on inner sidewall second end 108 lie substantially in a first plane P1 and, accordingly, inner sidewall second end 108 uniformly contacts any planar surface with which inner sidewall second end 108 is abutted. The abutting contact forms a substantially gas-tight seal at the interface between inner sidewall second end 108 and any likewise substantially planar surface. As shown in FIG. 1B, inner sidewall 102 has an inner sidewall diameter 102D.

As used herein, all points of inner sidewall second end 108 are said to lie substantially in P1 wherever no point on inner sidewall second end 108 departs from planarity by an amount that would interfere with the effective operation of actuator piece 10 in use with a pressurized gas drain opener, as described in more detail below. Also, as used herein, the seal formed at the interface between inner sidewall second end 108 and any planar surface is said to be substantially gas-tight whenever the gas seal is sufficiently unyielding to allow use of actuator piece 10 with a pressurized gas drain opener to effectively remove a blockage in a drain. Thus, a gas-tight seal is formed at the interface between planar inner sidewall second end 108 and any planar surface with which inner sidewall second end 108 is abuttingly contacted. Similarly, all points on outer sidewall second end 114 lie in a second plane P2 and, accordingly, outer sidewall second end 114 uniformly contacts any planar surface with which it is abutted. Thus, a gas-tight seal is formed at the interface between planar outer sidewall second end 114 and any planar surface with which outer sidewall second end 114 is abuttingly contacted.

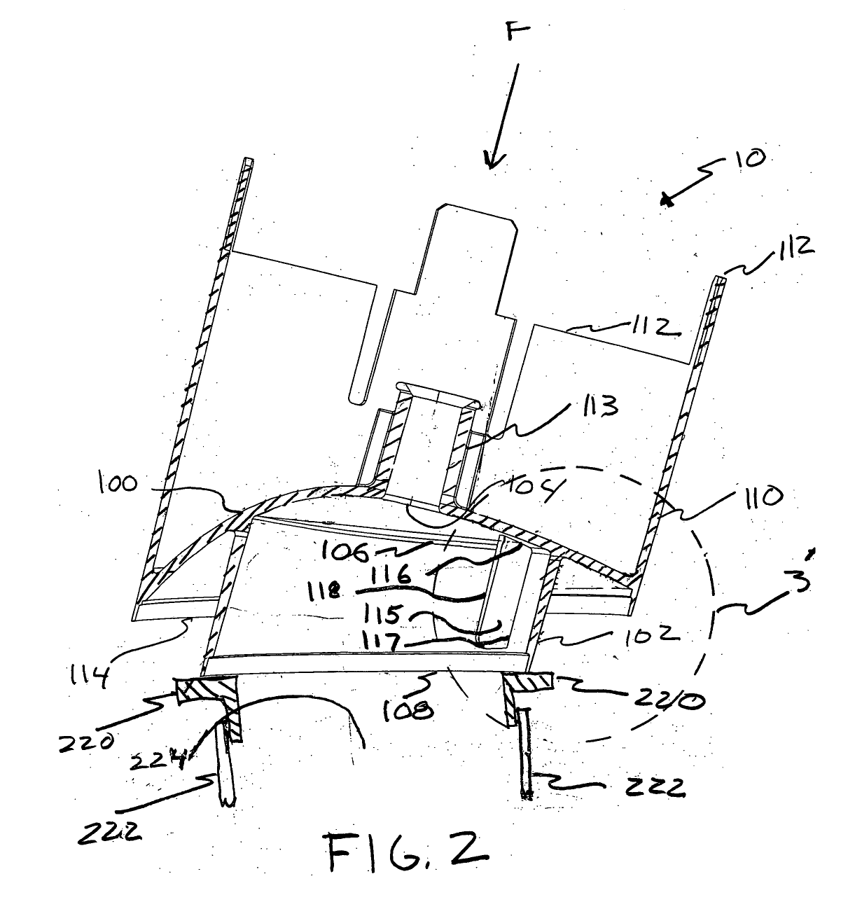

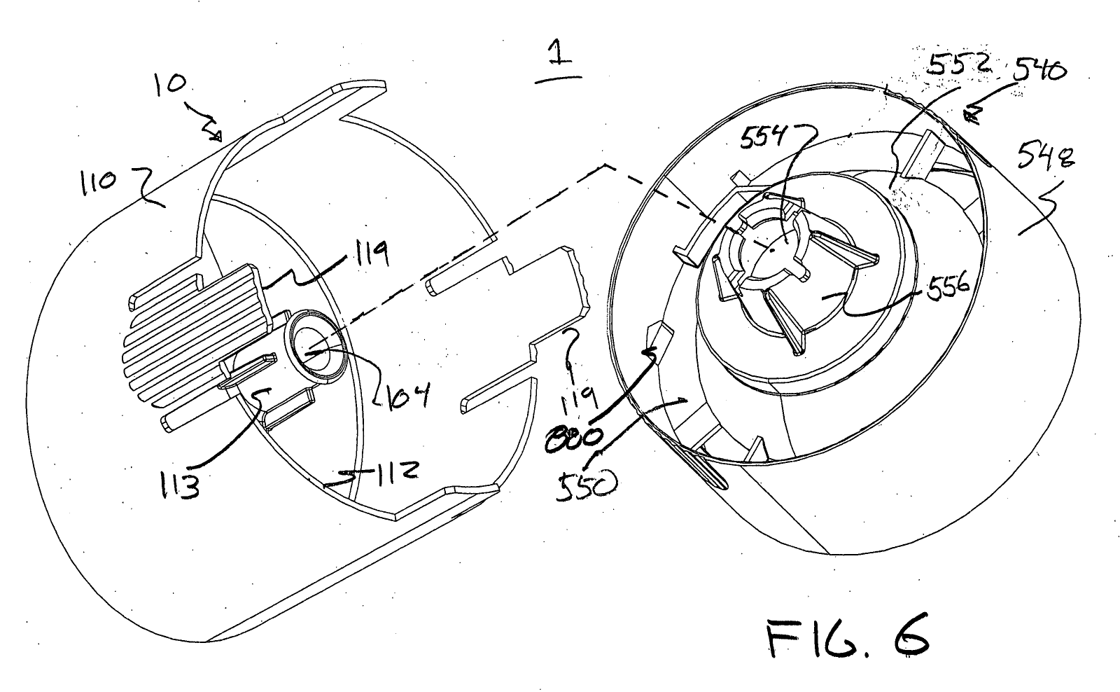

FIG. 2 is a cross-sectional side view of actuator piece 10 shown in FIG. 1A taken along the line 2′ [symbol] 2′ and positioned for use with a pressurized gas drain clearing device. As described more fully below with reference to FIG. 6, actuator piece 10 further includes a cylindrically shaped valve actuator element 113 coupled to actuator dome 100, circumscribing actuator aperture 104 adjacent the peripheral edge of actuator aperture 104, and projecting from actuator dome 100 in a direction toward outer sidewall first end 112. Referring to FIG. 2, actuator piece 10 is positioned such that inner sidewall second end 108 of inner sidewall 102 is placed in abutting contact with a sink drain flange 220 of a sink drain 222 servicing a sink (not shown). Typically, sink drain flange 220 is configured as a planar annulus circumscribing a sink drain opening 224 of sink drain 222 at the sink surface of the sink. As shown, drain flange 220 also typically includes a downwardly projecting end piece for connection of drain flange 220 to sink drain 222. Since as noted above, all points on inner sidewall second end 108 lie substantially in a plane, such as first plane P1 of FIG. 1B, inner sidewall second end 108 uniformly contacts sink drain flange 220. A substantially gas-tight seal is formed at the interface between inner sidewall second end 108 and sink drain flange 220.

The gas-tightness of the seal formed at the interface between inner sidewall second end 108 and sink drain flange 220 may be enhanced if inner sidewall second end 108 is biased toward sink drain flange 220. By application of biasing force F by a user of actuator piece 10 in a direction toward sink drain flange 220, i.e., substantially along the direction of the length of inner sidewall 102 toward sink drain flange 220. The gas-tightness of the seal formed at the interface between inner sidewall second end 108 and sink drain flange 220 may also be enhanced if the material of construction of inner sidewall 102 is selected to be sufficiently elastic to allow inner sidewall second end 108 of inner sidewall 102 to conform to irregularities present in any actual planar surface, such as sink drain flange 220.

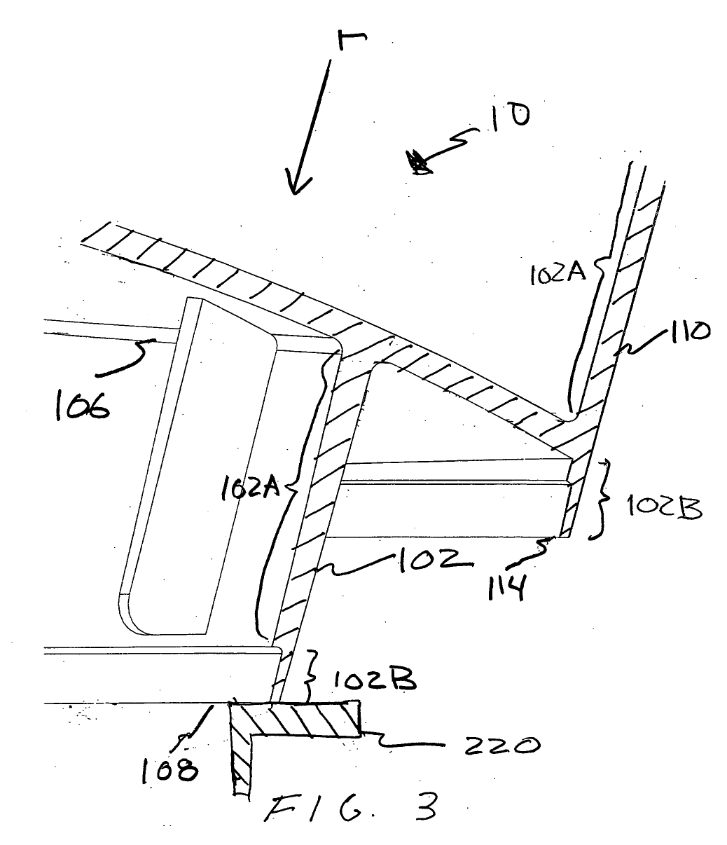

FIG. 3 is a close-up view of the area shown in dotted line and referenced by reference number 3′ on FIG. 2. In one embodiment of actuator piece 10, inner sidewall 102 comprises an inner sidewall thick portion 102A and an inner sidewall thin portion 102B contiguous with inner sidewall thick portion 102A. Inner sidewall thin portion 102B includes inner sidewall second end 108. Inner sidewall thin portion 102B has a thickness less than the thickness of inner sidewall thick portion 102A. Said another way, the thickness of inner sidewall 102 steps down, sometimes called necks-down, at the juncture of inner sidewall thick portion 102A and inner sidewall thin portion 102B. In the embodiment shown in FIG. 3, the surface of inner sidewall second end 108 of inner sidewall thin portion 102B presents an area less than the area that would be presented by the end surface of inner sidewall second end 108 if inner sidewall second end 108 had a uniform thickness equal to inner sidewall thick portion 102A, i.e., if inner sidewall second end 108 did not neck-down at the juncture of inner sidewall thick portion 102A and inner sidewall thin portion 102B. In other embodiments, inner sidewall 102 and outer sidewall 110 are uniform in thickness.

In FIG. 3, biasing force F applied by a user substantially along the direction of the length of inner sidewall 102 toward sink drain flange 220 is distributed over the relatively small area of inner sidewall second end 108 of inner sidewall thin portion 102B. In this manner, the unit sealing pressure, i.e., sealing force per unit contact area that is realized at the interface of inner sidewall second end 108 of inner sidewall thin portion 102B, is increased, thereby creating a more effective gas-tight seal. Further, for elastic materials of construction, at higher unit sealing pressures, inner sidewall second end 108 more closely conforms to planar irregularities present in sink drain flange 220. Still further, inner sidewall second end 108 of inner sidewall thin portion 102B more easily splays outwardly or inwardly from inner sidewall thick portion 102A by pivoting about the juncture of inner sidewall thick portion 102A and inner sidewall thin portion 102B. In this manner, inner sidewall second end 108 again may more closely conform to planar irregularities present in sink drain flange 220. As described more fully below with reference to FIG. 4B, in a similar manner, in this embodiment, outer sidewall 110 comprises an outer sidewall thick portion 110A and an outer sidewall thin portion 110B contiguous with outer sidewall thick portion 110A. Outer sidewall thin portion 110B includes outer sidewall second end 114. Outer sidewall thin portion 110B has a sidewall thickness less than the sidewall thickness of outer sidewall thick portion 110A. Said another way, the sidewall thickness of inner sidewall 102 necks-down at the juncture of inner sidewall thick portion 102A and inner sidewall thin portion 102B.

Those of ordinary skill in the art would recognize that the necking-down of the inner sidewall 102 and outer sidewall 110 described above are not necessary to form a substantially gas-tight seal. The skill artesian would also recognize that other means are possible to improve the substantiality of the gas seal. For example, inner sidewall second. end 108 and outer sidewall second end 114 may comprise elastomeric material or may further comprise a gasket, such as an “O” ring, coupled to second ends 108 and 114, to form more effective gas-tight seals.

FIG. 4A is a cross-sectional side view of actuator piece 10 shown in FIG. 1A positioned in abutting contact with a bathroom sink drain flange 420B of a typical bathroom sink 426B. FIG. 4B is a cross-sectional side view of actuator piece 10 shown in FIG. 1A positioned in abutting contact with a kitchen sink drain flange 420K of a typical kitchen sink 426K. Referring first to FIG. 4A, in one embodiment of actuator piece 10, inner sidewall 102 is configured to enable inner sidewall second end 108 to make abutting contact with and form a substantially gas-tight seal with a bathroom sink drain flange 420B sized within the range of sink flanges used with a typical bathroom sink 426B. Bathroom sink drain flange 420B is typically configured as a planar annulus having a bathroom sink drain flange diameter D_{B} of about 1.25 inches at a bathroom sink drain opening 424B of a bathroom sink drain 422B connected to bathroom sink 426B. Bathroom sink drain flange 420B has a bathroom sink drain flange width W_{B} of about 0.5 inches. Further, as described more fully below with reference to FIG. 4B, an inner sidewall extension portion 102X of inner sidewall 102 extends beyond outer sidewall second end 114 of outer sidewall 110 such that inner sidewall second end 108 abuttingly contacts bathroom sink drain flange 420B without outer sidewall second end 114 contacting bathroom sink surface 428B of bathroom sink 426B. In this manner, inner sidewall second end 108 may form a substantially gas-tight seal with bathroom sink drain flange 420B without concern that outer sidewall second end 114 may contact bathroom sink surface 428B, lift inner sidewall second end 108, and break the integrity of the seal between inner sidewall second end 108 and bathroom sink drain flange 420B.

In one embodiment, actuator piece 10 may be used with a pressurized gas sink drain clearing device in a bathroom sink drain 422B that contains a remotely operated drain stopper 434, common in bathroom sink 426B and well know to those of ordinary skill in the art. Prior to use, drain stopper 434 is raised by a drain stopper stem 436 to open bathroom sink drain 422B at bathroom sink drain opening 424B. Inner sidewall 102 (FIG. 4A) has sufficient length and actuator dome 100 is sufficiently removed from inner sidewall second end 108 such that the raised drain stopper 434 is contained within actuator piece 10 without contacting any part of inner sidewall 102 or actuator dome 100. At the same time, inner sidewall second end 108 may be placed in abutting contact with bathroom sink drain flange 420B to form a substantially gas-tight seal. A surge of pressurized gas from a pressurized gas sink drain clearing device may be directed around the raised drain stopper 434 and through bathroom sink drain opening 424B to impinged on a blockage in bathroom sink drain 422B.

As noted above, inner sidewall second end 108 is inclined with respect to inner sidewall 102. In one embodiment, inner sidewall second end 108 is inclined with respect to inner sidewall 102 at an incline angle α (FIG. 4A) of about 75°. In other embodiments, incline angle α may be greater or less than 75°. Thus, when a user of actuator piece 10 attempts to enhance the gas-tightness of a seal formed at the interface between inner sidewall second end 108 and bathroom sink drain flange 420B by application of biasing force F, biasing force F resolves to a biasing force vertical component Fᵥ normal to the top flange surface of bathroom sink drain flange 420B and a biasing force horizontal component F_{H} lateral to the top flange surface of bathroom sink drain flange 420B. Due to the action of biasing force horizontal component F_{H}, inner sidewall second end 108 will tend to slip in a lateral or horizontal direction with respect to bathroom sink drain flange 420B. Horizontal slippage tends to disrupt the integrity of the seal, thereby lowering the efficiency of the operation of actuator piece 10 due to pressure loss at the disrupted seal.

FIG. 1C is a bottom plan view of actuator piece 10 shown in FIG. 1A. Actuator piece 10 may further comprise one or more generally rectangular shaped actuator gusset 115 (FIGS. 1A, 1C, 2, and 4) coupled to actuator dome 100 at an actuator gusset dome coupling edge 116. Actuator gusset 115 is also coupled to inner sidewall 102 at an actuator gusset sidewall coupling edge 117. Actuator gusset 115 serves to strengthen inner sidewall 102. In one aspect of the present invention, actuator gusset 115 further comprises an actuator gusset stopper edge 118 opposite actuator gusset sidewall coupling edge 117. Actuator gusset stopper edge 118 is configured to allow abutting contact of actuator gusset stopper edge 118 with the peripheral edge of a drain stopper 434 (FIG. 4A) when it is raised above bathroom sink 426B. Thus, horizontal slippage of actuator piece 10 abates when actuator gusset stopper edge 118 abuttingly contacts the peripheral edge of the raised drain stopper 434. Biasing force horizontal component F_{H} transfers as a bending moment on the drain stopper stem 436 (FIG. 4A) that raises drain stopper 434 above bathroom sink drain flange 420B. Biasing force vertical component Fᵥ remains to provide a vertical biasing force normal to bathroom sink drain flange 420B that effectuates a substantially gas-tight seal at the interface between inner sidewall second end 108 and bathroom sink drain flange 420B.

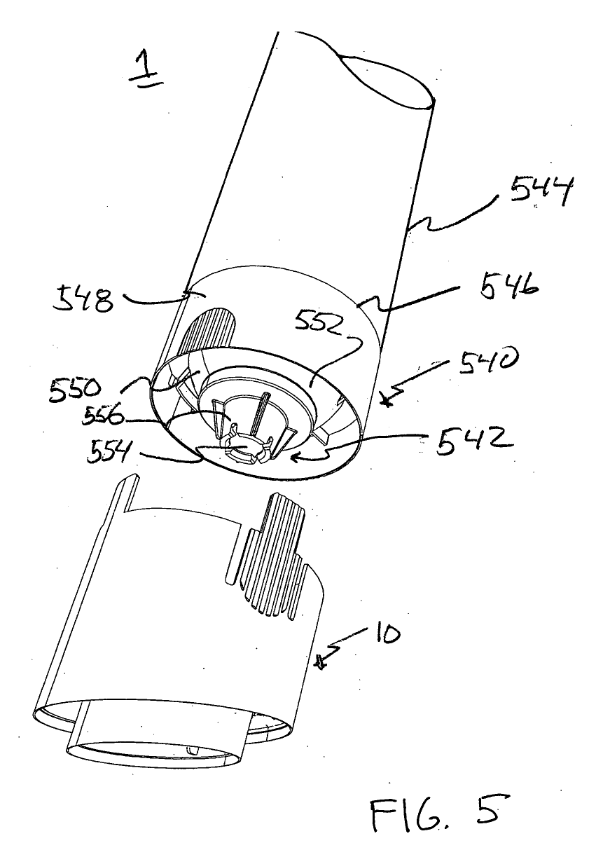

As described more fully below with reference to FIG. 5, actuator piece 10 may also be coupled to a pressurized gas sink drain clearing device utilizing a pressurized, cylindrically shaped aerosol can 544 (FIG. 5) even when an interfering water faucet (not shown) is positioned directly above bathroom sink drain flange 420B (FIG. 4A) at a distance less than the length of aerosol can 544. As noted above, inner sidewall second end 108 is inclined by an incline angle α (FIG. 4A) with respect to inner sidewall 102. Said another way, actuator piece 10 has a slanted inner sidewall second end 108. If aerosol can 544 is coupled to actuator piece 10 such that the length of aerosol can 544 is directed along the length of outer sidewall 110, as shown in FIG. 5, aerosol can 544 likewise slants with respect to bathroom sink drain flange 420B. Thus, in this embodiment, aerosol can 544 coupled to actuator piece 10 slants away from and may be made to clear the bathroom sink faucet even when the distance between the faucet and bathroom sink drain flange 420B is less than the length of aerosol can 544. By selecting the degree of inclination of inclination angle α of inner sidewall second end 108 with respect to inner sidewall 102, aerosol can 544 clears the faucet while at the same time inner sidewall second end 108 may be placed in abutting contact with bathroom sink drain flange 420B to form a substantially gas-tight seal.

Referring now to FIG. 4B, outer sidewall 110 is configured to enable outer sidewall second end 114 to make abutting contact with and form a substantially gas-tight seal with kitchen sink drain flange 420K sized within the range of kitchen sink drain flange 420K used with a typical kitchen sink 426K. Kitchen sink drain flange 420K is typically larger than the typical bathroom sink drain flange 420B shown in FIG. 4A. Kitchen sink drain flange 420K is further typically configured as a necked-down planar annulus having a kitchen sink drain flange diameter D_{K} of about 1.75 inches circumscribing a kitchen sink drain opening 424K of a kitchen sink drain 422K connected to kitchen sink 426K. Kitchen sink drain flange 420K has a kitchen sink drain flange width W_{K} of about 1.25 inches. As shown in FIG. 4B, a typical kitchen sink drain flange 420K necks-down at a kitchen sink flange neck 430 over a kitchen sink flange shoulder 432K to fit into kitchen sink drain opening 424K having a diameter greater than kitchen sink drain flange diameter D_{K}.

As described above with reference to FIGS. 1A, 1B, and 2, actuator piece 10 is positioned such that outer sidewall second end 114 of outer sidewall 110 is placed in abutting contact with a kitchen sink drain flange 420K, or, more specifically, with kitchen sink flange shoulder 432K, of kitchen sink drain 422K servicing kitchen sink 426K. Since as noted above, all points on outer sidewall second end 114 lie substantially in a plane such as second plane P2 of FIG. 1B, outer sidewall second end 114 may uniformly abuttingly contact kitchen sink drain flange 420K. A substantially gas-tight seal is effected at the interface between outer sidewall second end 114 and kitchen sink drain flange 420K, or, more specifically, kitchen sink flange shoulder 432K.

In a manner similar to that described above with reference to inner sidewall second end 108, the gas-tightness of the seal formed at the interface between outer sidewall second end 114 and kitchen sink flange shoulder 432K may be enhanced if outer sidewall second end 114 is biased toward kitchen sink flange shoulder 432K by application of biasing force F by a user of actuator piece 10 in a direction toward kitchen sink drain flange 420K, i.e., substantially along the length outer sidewall second end 114 toward kitchen sink drain flange 420K. Likewise, in a manner similar to that described above with reference to inner sidewall second end 108, the gas-tightness of the seal formed at the interface between outer sidewall second end 114 and kitchen sink flange shoulder 432K may also be enhanced if the material of construction of outer sidewall second end 114 is sufficiently elastic to allow outer sidewall second end 114 to conform to irregularities present in kitchen sink flange shoulder 432K of kitchen sink drain flange 420K. Further, as described above with inner sidewall second end 108 in FIG. 3, outer sidewall 110 comprises an outer sidewall thick portion 110A and an outer sidewall thin portion 110B contiguous with outer sidewall thick portion 110A. Outer sidewall thin portion 110B includes outer sidewall second end 114 outer sidewall thin portion 110B has a thickness less than the thickness of outer sidewall thick portion 110A, i.e., outer sidewall 110 necks-down at the juncture of outer sidewall thick portion 110A and outer sidewall thin portion 110B. Accordingly, the gas-tightness of a seal between outer sidewall second end 114 and kitchen sink flange shoulder 432K of kitchen sink drain flange 420B is enhanced.

As described above with reference to FIG. 4A, in use of actuator piece 10 with bathroom sink 426B, inner sidewall extension portion 102X of inner sidewall 102 extends beyond outer sidewall second end 114 of outer sidewall 110 such that inner sidewall second end 108 abuttingly contacts bathroom sink drain flange 420B without outer sidewall second end 114 contacting bathroom sink surface 428B of bathroom sink 426B.

When actuator piece 10 is also intended for use with a kitchen sink 426K as described and as shown in FIG. 4B, inner sidewall extension portion 102X extends a distance beyond outer sidewall second end 114 by a length less than the length of kitchen sink drain neck 430K. Thus, inner sidewall extension portion 102X and inner sidewall diameter (FIG. 1B) on inner sidewall 102 may be selected such that inner sidewall extension portion 102X fits within the recess formed by kitchen sink drain neck 430K and kitchen sink drain shoulder 432K without contacting a kitchen sink surface 428K of kitchen sink 426K. Thus, in this manner, outer sidewall second end 114 may form a substantially gas-tight seal with kitchen sink drain flange 420K without concern that inner sidewall second end 108 may contact kitchen sink drain neck 430K or kitchen sink drain shoulder 432K, lift outer sidewall second end 114 and break the integrity of the seal between outer sidewall second end 114 and kitchen sink drain flange 420K, or, more specifically, kitchen sink drain shoulder 432K.

In one embodiment, actuator piece 10 may be used with a bathtub drain (not shown). For some typical bathtub drains, actuator piece 10 fits a bathtub drain flange (not shown) as described above with reference to FIG. 4A and bathroom sink 426B, i.e., inner sidewall 102 forms a seal with the bathtub drain flange. For other typical, but slightly larger diameter bathtub drains (not shown), actuator piece 10 fits the bathtub drain flange (not shown) as described above with reference to FIG. 4B and kitchen sink 426K, i.e., outer sidewall 110 forms a seal with the bathtub drain flange.

FIG. 5 is an assembly view of one embodiment of an actuator 1 that further includes a coupling piece 540 slidably coupled to actuator piece 10 at an actuator piece retaining portion 542 of coupling piece 540. In one embodiment, coupling piece 540 is also coupled to aerosol can 544 at aerosol can retaining portion 546 of coupling piece 540 opposite actuator retaining portion 542. FIG. 6 is an exploded isometric view of actuator 1 comprising actuator piece 10 and coupling piece 540 shown in FIG. 5. Referring to FIGS. 5 and 6 together, coupling piece 540 comprises a cylindrically shaped coupling piece sidewall 548, an annularly shaped coupling piece annular portion 550 coupled to the inside surface of coupling piece sidewall 548 at the outside peripheral edge of coupling piece annular portion 550, and a generally convex shaped coupling piece dome 552 coupled to coupling piece annular portion 550 at the inside peripheral edge of coupling piece annular portion 550. In one embodiment, coupling piece annular portion 550 and coupling piece dome 552 are together generally configured to receive the dome shaped top (not shown) of a typical “211×713” type aerosol can 544, well known to those of ordinary skill in the art. It is understood, however, that coupling piece 540 may be used with other sizes or configurations of aerosol cans. Coupling piece annular portion 550 further defines a coupling piece aperture 554 therethrough. Circumscribing coupling piece aperture 554 is a valve actuator element receiver 556. In this embodiment, valve actuator element receiver 556 is configure as a frusto-conically shaped sidewall coupled to coupling piece dome 552 and projecting in a direction away from coupling piece dome 552. Further, valve actuator element receiver 556 is configured to enclose the valve (not shown) of aerosol can 544. Finally, valve actuator element receiver 556 is further configured to snap-fit over valve actuator element 113 (FIGS. 1D and 6) of actuator piece 10 and thereafter rotatably and slidably engage valve actuator element 113 in a direction about and along the cylindrical axis of valve actuator element 113.

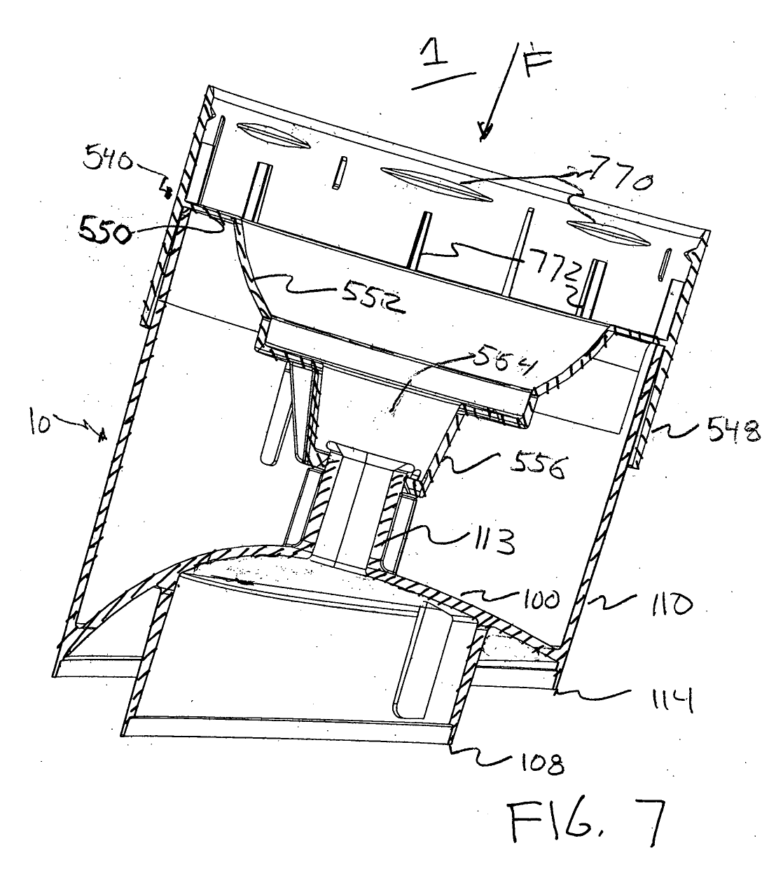

FIG. 7 is a cross-sectional side view of actuator 1 after valve actuator element receiver 556 is snap-fitted over valve actuator element 113. Coupling piece 540 further includes one or more coupling piece ledges 770 coupled to the interior surface of coupling piece sidewall 548 and configured as wedge shaped protrusions directed inwardly toward coupling piece aperture 554. Also coupled to the interior surface of coupling piece sidewall 548 below each 558 is a coupling piece gusset 772 configured generally as a rectangular shaped gusset-like protrusion projecting inwardly toward coupling piece aperture 554.

In operation of a pressurized gas sink drain clearing device utilizing actuator 1, the rounded top-seam or chime (not shown) of aerosol can 544 (FIG. 5), well know to those of ordinary skill in the art, is wedged between coupling piece ledges 770 and coupling piece gussets 772 (FIG. 7) to securely couple aerosol can 544 to coupling piece 540. As noted above, at the same time, the valve (not shown) of aerosol can 544 (FIG. 5) is disposed within valve actuator element receiver 556 and the dome shaped top (not shown) of aerosol can 544 is disposed within coupling piece annular portion 550 and coupling piece dome 552. Next, either inner sidewall second end 108 is placed in abutting contact with bathroom sink drain flange 420B of bathroom sink 426B (FIG. 4A) or outer sidewall second end 114 is placed in abutting contact with kitchen sink drain flange 420K of kitchen sink 426K (FIG. 4B). Next, a user applies biasing force F to form a substantially gas-tight seal. The application of biasing force F also motivates actuator piece 10 the slide with respect to coupling piece 540 (FIG. 5) and more particularly for valve actuator element receiver 556 to slide with respect to valve actuator element 113 toward actuator dome 100 (FIG. 7). As valve actuator element receiver 556 slides toward actuator dome 100, valve actuator element 113 contacts and depresses the valve (not shown) of aerosol can 544 (FIG. 5) and thereby releases the pressurized gas contained in aerosol can 544 to impinge on and clear any blockage in bathroom sink drain 422B or kitchen sink drain 422K.

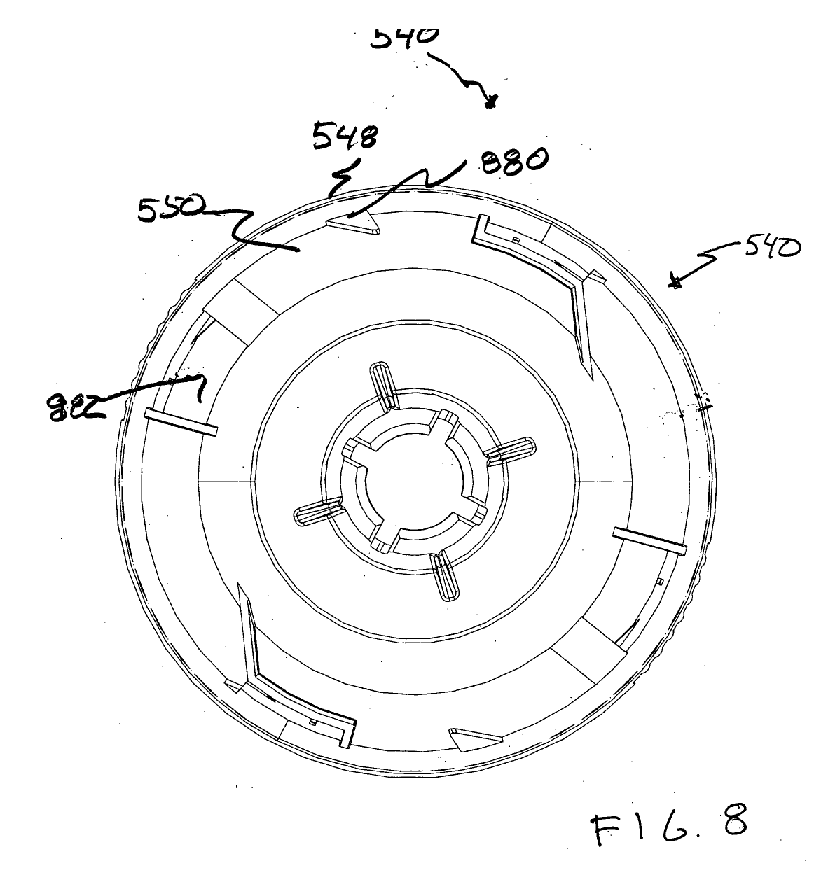

FIG. 1D is a top plan view of actuator piece 10 shown in FIG. 1A. FIG. 8. is a bottom plan view of coupling piece 540 shown in FIG. 5. Referring to FIGS. 1D, 6, and 8 together, in one embodiment actuator 1 includes child resistant features that tend to preclude operation of actuator 1 by a child. In this embodiment, actuator piece 10 may not slide with respect to coupling piece 540, until certain actions are first performed. These actions are difficult to perform by a child. Since actuator piece 10 may not slide with respect to coupling piece 540 until certain actions are first performed, and more particularly, since valve actuator element receiver 556 may not slide with respect to valve actuator element 113 toward actuator dome 100 (FIG. 7), the valve (not shown) of aerosol can 544 (FIG. 5) may not be accidentally actuated to release pressurized gas from aerosol can 544.

In one embodiment, actuator piece 10 includes at least one flexible tab 119, which is flexibly movable inwardly toward actuator aperture 104 and forms a part of outer sidewall 110. In this embodiment, flexible tab 119 extends beyond outer sidewall first end 112 of outer sidewall 110 and contacts coupling piece annular portion 550 of coupling piece 540, thereby precluding slidable motion of actuator piece 10 with respect to coupling piece 540. This embodiment, includes a tab stop 880 coupled to coupling piece sidewall 548 and coupling piece annular portion 550. Tab stop 880 is configured to preclude rotation of actuator piece 10 with respect to coupling piece 540 when flexible tab 119 is in a relaxed position, i.e., unflexed inwardly, and actuator piece 10 is rotated to angularly positioned actuator piece 10 relative to coupling piece 540 such that tab stop 880 contacts flexible tab 119. When actuator piece 10 is so positioned relative to coupling piece 540, actuator 1 is said to be in a safety position. Thus, in the safety position, actuator piece 10 may move neither slidably nor rotationally with respect to coupling piece 540.

Actuator 1 is normally supplied with valve actuator element receiver 556 of coupling piece 540 snap-fitted over valve actuator element 113 (FIG. 7) of actuator piece 10 in a safety position. As shown in FIG. 8, coupling piece 540 includes a coupling piece slot 882 configured as an opening through coupling piece annular portion 550 at coupling piece sidewall 548. Coupling piece slot 882 is further configured to allow flexible tab 119 to pass through coupling piece slot 882 when flexible tab 119 is in a relaxed position. In operation, flexible tab 119 is flexed inwardly a sufficient distance to clear tab stop 880, thereby allowing actuator piece 10 to rotate relative to coupling piece 540. actuator piece 10 is next rotated relative to coupling piece 540 such that flexible tab 119 is positioned above coupling piece slot 882. Flexible tab 119 is then relaxed. In this position, actuator 1 is said to be in an armed position. In the armed positioned slidable motion of actuator piece 10 with respect to coupling piece 540 is possible since flexible tab 119 passes through coupling piece slot 882 when 10 is slidable moved toward coupling piece 540. In the armed position, actuator 1 may be used with aerosol can 544 as described above to actuate the valve of aerosol can 544 and impinge a pressurized gas to clear a drain blockage.

In one embodiment of actuator 1, the components comprising actuator piece 10 can be formed integrally, and the components comprising coupling piece 540 may be formed integrally. Actuator piece 10 and coupling piece 540 can be made of any suitable material, including but not limited to, metal, metal composites, polypropylene (PP), high density polyethylene (HDPE), low density polyethylene (LDPE), polyethylene terephthalate (PET), polystyrene (PS), acrylonitrile-butadiene-styrene (ABS), polymer composites, and other engineered plastics that are formed into desired shapes with a variety of fabrication technologies.

Those of skill in the art will recognize that other variations on the size and shape of the components making up actuator 1 are possible. Further, the embodiments herein are illustrated in the context of an actuator for use with a pressurized gas aerosol can drain clearing device. The skilled artisan will readily appreciate, however, that the structures disclosed have application in a number of other contexts where an aerosol can actuator is important.

Finally, this invention has been described herein in considerable detail to provide those skilled in the art with information relevant to apply the novel principles and to construct and use such specialized components as are required. However, it is to be understood that the invention can be carried out by different components, materials and devices, and that various modifications can be accomplished without departing from the scope of the invention.

What is claimed is:

1. An actuator comprising an actuator piece comprising:
an actuator dome, said actuator dome defining an actuator aperture therethrough;
at least one sidewall having a sidewall first end and a sidewall second end opposite said sidewall first end, said at least one sidewall being coupled to said actuator dome; and
wherein said at least one sidewall circumscribes said actuator aperture.

2. The actuator of claim 1 wherein said actuator is coupled to a pressurized gas sink drain clearing device.

3. The actuator of claim 2 wherein said pressurized gas sink drain clearing device comprises an aerosol can.

4. The actuator of claim 1 wherein said second end of said at least one sidewall defines a plane, said plane being inclined with respect to said sidewall at an incline angle.

5. The actuator of claim 4 wherein said incline angle is about 75°.

6. The actuator of claim 1 wherein said actuator dome is concavely shaped and wherein said at least one sidewall is cylindrically shaped.

7. The actuator of claim 1 wherein said second end of said at least one sidewall forms a substantially gas-tight seal with a planar surface.

8. The actuator of claim 1 wherein said at least one sidewall comprises an elastic material that allows said second end of said at least one sidewall to conform to planar irregularities present in said planar surface.

9. The actuator of claim 7 wherein said planar surface is a sink flange.

10. The actuator of claim 1 further comprising a valve actuator element coupled to said actuator dome.

11. The actuator of claim 10:
wherein said valve actuator element is cylindrically shaped;
wherein said valve actuator element circumscribes said actuator aperture adjacent the peripheral edge of said actuator aperture; and
wherein said valve actuator element projects from said actuator dome in a direction toward said sidewall first end of said at least one sidewall.

12. The actuator of claim 1 wherein said at least one sidewall comprises:
a sidewall thick portion; and
a sidewall thin portion contiguous with said sidewall thick portion, said sidewall thin portion including said sidewall second end of said at least one sidewall.

13. The actuator of claim 1 further comprising at least one actuator gusset coupled to said actuator dome and to said at least one sidewall.

14. The actuator of claim 1 wherein said actuator piece is integrally formed.

15. The actuator of claim 1 wherein said actuator piece is formed from a material selected from the group consisting of metal, metal composites, polypropylene (PP), high density polyethylene (HDPE), low density polyethylene (LDPE), polyethylene terephthalate (PET), polystyrene (PS), acrylonitrile-butadiene-styrene (ABS), polymer composites, and other engineered plastics.

16. An actuator comprising an actuator piece comprising:
an actuator dome, said actuator dome defining an actuator aperture therethrough;
an inner sidewall having an inner sidewall first end and an inner sidewall second end opposite said inner sidewall first end, said inner sidewall being coupled to said actuator dome and said inner sidewall circumscribing said actuator aperture; and
an outer sidewall having an outer sidewall first end and an outer sidewall second end opposite said outer sidewall first end, said outer sidewall being coupled to said actuator dome, and said outer sidewall circumscribing said actuator aperture.

17. The actuator of claim 16 wherein said actuator is used with a pressurized gas sink drain clearing device.

18. The actuator of claim 17 wherein said pressurized gas sink drain clearing devices comprises an aerosol can.

19. The actuator of claim 16 wherein said inner sidewall second end defines a plane, said plane being inclined with respect to said inner sidewall at an incline angle.

20. The actuator of claim 19 wherein said incline angle is about 75°.

21. The actuator of claim 16 wherein said outer sidewall second end defines a plane, said plane being inclined with respect to said outer sidewall at an incline angle.

22. The actuator of claim 21 wherein said incline angle is about 75°.

23. The actuator of claim 16:
wherein said actuator dome is concavely shaped;
wherein said at inner sidewall is cylindrically shaped; and
wherein said at outer sidewall is cylindrically shaped.

24. The actuator of claim 16:
wherein said inner sidewall second end forms a substantially gas-tight seal with a planar surface; and
wherein said outer sidewall second end forms a substantially gas-tight seal with said planar surface.

25. The actuator of claim 16 wherein said inner sidewall and said outer sidewall comprises an elastic material that allows said inner sidewall second end and said outer sidewall second end to conform to planar irregularities present in said planar surface.

26. The actuator of claim 25 wherein said planar surface is a sink flange.

27. The actuator of claim 16 further comprising a valve actuator element coupled to said actuator dome.

28. The actuator of claim 27:
wherein said valve actuator element is cylindrically shaped;
wherein said valve actuator element circumscribes said actuator aperture adjacent the peripheral edge of said actuator aperture; and
wherein said valve actuator element projects from said actuator dome in a direction toward said inner sidewall first end.

29. The actuator of claim 16 wherein said inner sidewall comprises:
an inner sidewall thick portion; and
an inner sidewall thin portion contiguous with said inner sidewall thick portion, said inner sidewall thin portion including said inner sidewall second end; and
wherein said outer sidewall comprises:
an outer sidewall thick portion; and
an outer sidewall thin portion contiguous with said outer sidewall thick portion, said outer sidewall thin portion including said outer sidewall second end.

30. The actuator of claim 16 further comprising at least one actuator gusset coupled to said actuator dome and to said inner sidewall.

31. The actuator of claim 16 wherein said actuator piece is integrally formed.

32. The actuator of claim 16 wherein said actuator piece is formed from a material selected from the group consisting of metal, metal composites, polypropylene (PP), high density polyethylene (HDPE), low density polyethylene (LDPE), polyethylene terephthalate (PET), polystyrene (PS), acrylonitrile-butadiene-styrene (ABS), polymer composites, and other engineered plastics.

33. An actuator comprising:
an actuator piece comprising:
an actuator dome, said actuator dome defining an actuator aperture therethrough;
an inner sidewall having an inner sidewall first end and an inner sidewall second end opposite said inner sidewall first end, said inner sidewall being coupled to said actuator dome and said inner sidewall circumscribing said actuator aperture; and
a coupling piece slidably coupled to said actuator piece, said coupling piece comprising:
a coupling piece sidewall;
a coupling piece annular portion coupled to said coupling piece sidewall at the outside peripheral edge of said coupling piece annular portion; and
a coupling piece dome coupled to said coupling piece annular portion at the inside peripheral edge of said coupling piece annular portion.

34. The actuator of claim 33 wherein said actuator is used with a pressurized gas sink drain clearing device.

35. The actuator of claim 34 wherein said pressurized gas sink drain clearing devices comprises an aerosol can.

36. The actuator of claim 33 wherein said inner sidewall second end defines a plane, said plane being inclined with respect to said inner sidewall at an incline angle.

37. The actuator of claim 36 wherein said incline angle is about 75°.

38. The actuator of claim 33 wherein said outer sidewall second end defines a plane, said plane being inclined with respect to said outer sidewall at an incline angle.

39. The actuator of claim 38 wherein said incline angle is about 75°.

40. The actuator of claim 33:
wherein said actuator dome is concavely shaped;
wherein said at inner sidewall is cylindrically shaped; and
wherein said at outer sidewall is cylindrically shaped.

41. The actuator of claim 33:
wherein said inner sidewall second end forms a substantially gas-tight seal with a planar surface; and
wherein said outer sidewall second end forms a substantially gas-tight seal with said planar surface.

42. The actuator of claim 41 wherein said planar surface is a sink flange.

43. The actuator of claim 33 wherein said inner sidewall and said outer sidewall comprises an elastic material that allows said inner sidewall second end and said outer sidewall second end to conform to planar irregularities present in said planar surface.

44. The actuator of claim 33 further comprising a valve actuator element coupled to said actuator dome.

45. The actuator of claim 44:
wherein said valve actuator element is cylindrically shaped;
wherein said valve actuator element circumscribes said actuator aperture adjacent the peripheral edge of said actuator aperture; and
wherein said valve actuator element projects from said actuator dome in a direction toward said inner sidewall first end.

46. The actuator of claim 33 wherein said inner sidewall comprises:
an inner sidewall thick portion; and
an inner sidewall thin portion contiguous with said inner sidewall thick portion, said inner sidewall thin portion including said inner sidewall second end; and
wherein said outer sidewall comprises:
an outer sidewall thick portion; and
an outer sidewall thin portion contiguous with said outer sidewall thick portion, said outer sidewall thin portion including said outer sidewall second end.

47. The actuator of claim 33 further comprising at least one actuator gusset coupled to said actuator dome and to said inner sidewall.

48. The actuator of claim 33:
wherein said actuator piece is integrally formed; and
wherein said coupling piece is integrally formed.

49. The actuator of claim 33 wherein said actuator piece and said coupling are formed from a material selected from the group consisting of metal, metal composites, polypropylene (PP), high density polyethylene (HDPE), low density polyethylene (LDPE), polyethylene terephthalate (PET), polystyrene (PS), acrylonitrile-butadiene-styrene (ABS), polymer composites, and other engineered plastics.

50. The actuator of claim 33 wherein said coupling piece defines a coupling piece aperture therethrough.

51. The actuator of claim 50 wherein said coupling piece further comprises:
a valve actuator element receiver circumscribing said a coupling aperture

52. The actuator of claim 51 wherein said valve actuator element receiver is configured as a frusto-conical shaped sidewall coupled to said coupling piece dome and to enclose a valve of an aerosol can.

53. The actuator of claim 51 wherein said valve actuator element is configured to snap-fit over and slidably engage said valve actuator element of said actuator piece.

54. A method of cleaning a drain comprising:
providing an actuator comprising:
an actuator piece comprising:
an actuator dome, said actuator dome defining an actuator aperture therethrough;
a sidewall having a sidewall first end and a sidewall second end opposite said sidewall first end, said sidewall circumscribing said actuator aperture; and
a coupling piece coupled to and slidably engaging said actuator piece, said coupling piece comprising:
a coupling piece sidewall;
a coupling piece annular portion coupled to said coupling piece sidewall at the outside peripheral edge of said coupling piece annular portion; and
a coupling piece dome coupled to said coupling piece annular portion at the inside peripheral edge of said coupling piece annular portion;
coupling an aerosol can to said coupling piece, said aerosol can containing a pressurized gas;
placing said sidewall second end in abutting contact with a drain flange of said drain;
applying a biasing force in a direction substantially along the length of said sidewall toward said drain flange thereby establishing a substantially gas tight seal between said sidewall second end and said drain flange;
releasing said pressurized gas contained in said aerosol can through said actuator aperture to impinge on a blockage in said drain.

55. The method of claim 54 wherein said outer sidewall second end of said actuator piece defines a plane, said plane being inclined with respect to said outer sidewall of said actuator piece at an incline angle.

56. The method of claim 55 wherein said incline angle is about 75°.
